(19) United States
(12) Patent Application Publication
(10) Pub. No.: US 2023/0298117 A1
(43) Pub. Date: Sep. 21, 2023

(54) Automated Tokenization Of Property Rights

(71) Applicants: John Christian Barlow, Midway, UT (US); Michael William Waters, Taylorsville, UT (US)

(72) Inventors: John Christian Barlow, Midway, UT (US); Michael William Waters, Taylorsville, UT (US)

(21) Appl. No.: 18/063,560

(22) Filed: Dec. 8, 2022

Related U.S. Application Data
(63) Continuation-in-part of application No. 17/342,169, filed on Jun. 8, 2021, now abandoned.

(51) Int. Cl. G06Q 50/16; G06Q 20/36

(52) U.S. Cl. CPC G06Q 50/167; G06Q 20/3678

(57) ABSTRACT

A system for bridging between centralized and decentralized systems such that an owner can access equity in their property and a purchaser can have a high degree of confidence in the property rights being purchased. The system includes an equity conversion computer having software executing thereon to intake property information and property conversion software executing thereon to convert the real property rights to be collateralized into tokens to be registered on blockchain (decentralized system) and on government computer systems (centralized systems). The software intakes the information, saves the information in a usable format and generates various documents in formats usable by the various system the equity conversion computer communicates with. The tokenized property rights can then be converted to a crypto currency by a purchaser desiring to purchase the property rights associated with the tokens.

### FIELD OF THE INVENTION

This invention relates to a system for converting equity in a property to crypto currency, and more particularly, to a system and method for automatically converting a property right to a crypto currency.

### BACKGROUND OF THE INVENTION

Real Property can be thought of as a group of rights which can be divided from one another. These rights include but are not limited to: possession; control; use and quiet enjoyment; allow others a right to use; privacy and exclusion of others; disposition or transfer of the property to another by sale, gift, or inheritance; use of the property as collateral; water rights; surface rights; subsurface rights; air rights; development rights; improvement rights; right of equity, right to contract, right to manage, right to market, digital rights, right of occupancy, and any other rights, including negative, associated with real property ownership. The extractive, development, improvement, monetary, and investment rights are often subject to local laws, and can be subject to community regulations.

The primary right most used for financial gain is possession of the property. Possession of the property allows the owner to utilize the equity in the real property. There are essentially three financial instruments that allow a real property owner to utilize the equity in their real property: (1) Mortgage; (2) Home Equity Line of Credit or HELOC; (3) Reverse Mortgage. Traditionally, these financial instruments are associated with lending institutions such as banks and credit unions. Generally, these institutions utilize traditional monetary systems and have not embraced cryptocurrency. There are instances of financial institutions using cryptocurrency, or at least aspects of cryptocurrency, but they have not adopted such methods on a wide scale. Additionally, the financial institutions’ methods utilize a collateralization that will cost money and may result in foreclosure of the title.

The second most common method of utilizing the equity in real property is by disposing of the real property. However, this method deprives the owner of rights associated with land ownership and future gains derived from the land ownership.

During possession of the real property, the collateralization of rights in real property for the purpose of utilizing the equity to generate currency can be implemented at different times in the life of the property ownership. For example, upon creation of a residential or commercial development, or upon the purchase of an existing residence, or upon the purchase of a commercial property.

Initially, most trade went through a barter system, one asset was traded for another. A farmer would trade his produce to a cooper for barrels or other storage containers, the cooper would also trade his wares to a fisherman for fish, and whatever assets the individual had were used to trade for the assets the individual wanted. A currency system is only valuable if the people utilizing the system trust that the currency has value. In the United States each dollar printed was backed by a dollar’s worth of gold in the depository. If more representative currency was to be issued, more gold was brought in (either purchased or mined) to hold the value of the representative currency. This “Gold Standard” enabled people to trust that their representative currency held value. The “Gold Standard” meant that paper money was freely convertible to a fixed amount of gold. The “Gold Standard” was gradually abandoned by the countries of the world, with the last vestiges of the system eliminated in 1971.

Since then, the currencies of the world have been fiat currency. Fiat currencies are ultimately since they are defined as legal tender. This decree leads to the trust that people have in the currency, a country that has a high degree of trust from its people has a high degree of trust in its currency. Fiat currencies are not only dependent upon the trust that the citizens have in the government, but they are also dependent upon the decisions the government makes and the policies the government initiates. Governments can therefore adjust their policies to change the value of their currency. For example, a government can print paper currency so that the market is oversaturated, this devalues that currency, meaning it takes more of the currency to purchase a given commodity.

Throughout the use of commodity currency such as gold and silver coins to the current use of fiat currency, there have been alternative methods of making asset backed payments. Instead of trading a wagon full of produce, a farmer could trade a note for the wagon full of produce. An individual could trade a title to a home instead of the home itself. These assets backed payments enabled individuals to pay with assets without the necessity of transporting those assets. Unfortunately, there have always been those who are willing to take advantage of others and these individuals could create false assets, or assets that only existed on paper, and trade them to unsuspecting individuals. Many individuals lack the training and knowledge to identify assets that only appear on paper. This makes some asset backed instruments less appealing and less likely to be adopted. However, the value of an asset-backed currency is less likely to be adjusted by the decisions and policies of a government or influential individuals.

One limiting factor of using assets as currency is the difficulty in dividing the asset, this is especially true of larger assets such as homes and businesses. A home is not as valuable once each brick is being traded and the home is being taken apart.

Importantly, many property owners want to utilize equity related to their personal and real property. Currently, there are a limited number of methods available for real property owners to utilize the equity in their real property. These methods include obtaining a mortgage, a home equity line of credit, and / or a reverse mortgage. These methods, as stated above, are typically administered by financial institutions and require the applicant to apply for the loan and fill out the voluminous paperwork associated with such transactions. This can be a tedious and slow process with fees having to be paid by the property owner to access their equity. The entire process often deters individuals from utilizing the equity in their real property.

Additionally, real property owners have property rights associated with their real property that may not be utilized because of current constraints. These rights could include surface rights, such as the right to use the property to raise crops, or livestock, or water rights to the property. These rights can also include subsurface rights, such as the right to extract oil, gas, or minerals from the property. All these rights can be licensed to others, which typically take the form of a lease and / or a contract.

Additionally, tracking these rights is difficult because unlike county recorders offices where titles to real property are recorded and maintained, there generally is no unified and easily accessible recording system for the individual property rights. However, any current system used is completely centralized.

Country Recorder’s Offices are recognized as the current method for verifying title to real property. However, as the only current system they are slow and laborious and do not incorporate technological advances. County Recorder’s Offices are a fully centralized system.

Rights associated with real property. With the introduction of crypto currencies, many types of transactions can now be completed completely electronically without the need to involve a bank or financial institution. Crypto currency is fast and easy to use. However, no system has been developed that would allow a property owner to access the equity in their real property and convert that equity into a crypto currency. Real property presents unique challenges to the conversion of equity in that the property rights are controlled by the owner and are not easily transferable. Data relating to the real property and the rights associated therewith is not maintained in a format that can be easily accessed by a computer, nor is there any way to automatically transfer and hold those rights via a computer system. Still further, while the transfer of crypto currency has become widely known in recent years, setting the value of real property rights vis a vis a crypto currency has never been done.

Another challenge is that of trying to mesh very different types of systems including centralized systems (e.g., government computers and databases relating to real property rights) and decentralized systems (e.g., the blockchain and the various computers where the blockchain information is saved). To date, no system has been able to link these centralized and decentralized systems in a coherent manner.

### SUMMARY OF THE INVENTION

Accordingly, what is desired is a system and method for automatically tokenizing property rights to convert to a crypto currency with a computer.

It is further desired to provide a system and method for tokenizing property rights by using a governing entity to allow the property rights to be distributed.

It is still further desired to provide a system and method for tokenizing property rights by converting property information into a first format that can be used by the system to generate a property profile that is used to tokenize the property rights.

It is also desired to provide a system and method where real property rights are automatically tokenized and filed in blockchain such that a rights purchaser can purchase the tokens and the property rights associated with the tokens.

It is further desired to provide a system and method that can link the centralized government systems that record real property rights with the decentralized system that governs blockchain.

In one configuration, an equity conversion computer is provided that has a storage and is connected to a network such that a user computer operated by a user owning a property can securely log into the equity conversion computer. The property can comprise in one example, real property rights such as surface rights, subsurface rights, and the right of occupancy on the real property.

Once logged into the equity conversion computer, the user via the user computer is presented with a series of fields that can be filled out describing the real property including, for example but not limited to, the address, the acreage, the access to the real property, any studies and / or report that have been carried out with respect to the property, any improvements on the property, a detailed description of the improvements includes photographs of the property and improvements, the volume of bodies of water on the property, a description of any rivers or creeks that run across the property, the depth of any wells on the property and so on. Once the user has filled out the various property information fields on the property intake page(s), the software executing on the equity conversion computer will generate a property profile that may then be sent to the user for review and editing. If the property profile is correct and complete, the user may then confirm this with the equity conversion computer for the system to use in the tokenization of the property rights the owner desires to tokenize.

Software executing on the equity conversion computer then generates tokens corresponding to the property rights indicated by the user. The equity conversion computer will further generate a contract between the owner and a governing entity that allows for the tokenization of the property rights. In one example, the governing entity may comprise a Home Owner’s Association (HOA) or a Property Owner’s Association (POA). While most when thinking about a HOA or a POA view these entities as applying prescriptions to the property owners (e.g., controlling the style of the house, the color of the house, the type of landscaping that must be followed, limiting the structures that may be erected on the property, and so on), these types of entities may be used in a positive sense too (e.g., allowing for the tokenization of surface rights and subsurface rights, and so on). Accordingly, the equity conversion computer will automatically generate documents to place the property into a governing entity based on the location of the property. If a governing entity does not yet exist in the state where the property is located, software executing on the equity conversion computer will automatically generate governing entity documents to form the governing entity in the jurisdiction and once reviewed, will file those documents with a computer for the state to form the governing entity.

The equity conversion computer will also generate a smart contract associated with the tokenized property rights that will be filed on the blockchain. Additionally, the corresponding documents will be created by the equity conversion computer and will be filed with the appropriate county clerk’s office relating to the property rights so that a potential purchaser of the tokens associated with the property rights can verify the property rights with both the smart contract and with a review of the county records for the property.

Once the tokens are generated and the smart contract is filed in blockchain, the tokens are then transferred to the user’s electronic wallet. These tokens may then be put on sale for a rights purchaser to purchase with a crypto currency. Once a value for the property rights is determined between the buyer and seller, the software executing on the equity conversion computer can then transfer the amount of crypto currency from the buyer to the seller’s electronic wallet and the tokens in the seller’s electronic wallet are transferred to the buyer’s electronic wallet.

It will be understood by those of skill in the art that the electronic wallet of the seller will comprise Anti-Money Laundering (AML) information and Know Your Client (KYC) information. Additionally, software executing on the equity conversion computer may, at the time of inputting the property information, automatically generate the electronic wallet for the user.

In another aspect, the disclosure provides a system for accessing the value of real property. The system includes a real property; a computer readable medium for storing a computer program; a graphical user interface for viewing the real property and a value of the real property; a blockchain ledger, that records and stores information and transactions; cryptocurrency coins; a governing entity with authority over the possession; an issuing entity, which creates and issues cryptocurrency. The computer program communicates with the blockchain, and the computer program and blockchain are adapted to communicate with the governing entity and the issuing entity. Once the property has been entered into the program the governing entity authorizes the issuing entity to create cryptocurrency coins and issue those cryptocurrency coins to the owner of the possession. The computer program ensures that the cryptocurrency coins are recorded in the blockchain ledger.

In still another aspect the disclosure provides a system for accessing the value of a possession. The system includes a possession; a computer readable medium for storing a computer program; a graphical user interface for viewing the possession and a value of the real property; a blockchain ledger, that records and stores information and transactions; cryptocurrency coins; a governing entity with authority over the possession; an issuing entity, which creates and issues cryptocurrency. The computer program communicates with the blockchain, and the computer program and blockchain are adapted to communicate with the governing entity and the issuing entity. Once the possession has been entered into the program the governing entity authorizes the issuing entity to create cryptocurrency coins and issue those cryptocurrency coins to the owner of the possession. The computer program ensures that the cryptocurrency coins are recorded in the blockchain ledger.

In yet another aspect the disclosure provides a method for accessing the value of a possession. The system includes a possession; a computer readable medium for storing a computer program; a graphical user interface for viewing the possession and a value of the real property; a blockchain ledger, that records and stores information and transactions; cryptocurrency coins; a governing entity with authority over the possession; an issuing entity, which creates and issues cryptocurrency. The computer program communicates with the blockchain, and the computer program and blockchain are adapted to communicate with the governing entity and the issuing entity. Once the possession has been entered into the program the governing entity authorizes the issuing entity to create cryptocurrency coins and issue those cryptocurrency coins to the owner of the possession. The computer program ensures that the cryptocurrency coins are recorded in the blockchain ledger.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “process” and “processing” as used herein each mean an action or a series of actions including, for example, but not limited to, the continuous or non-continuous, synchronous or asynchronous, routing of data, modification of data, formatting and/or conversion of data, tagging or annotation of data, measurement, comparison and/or review of data, and may or may not comprise a program.

As used herein, the term “token” refers to a special virtual currency token or how cryptocurrencies are denominated. These tokens represent fungible and tradable assets or utilities that reside on their own blockchains. For example, one may have a crypto token that represents a certain number of customer loyalty points on a blockchain that is used to manage such details for a retail chain. There can be another crypto token that gives entitlement to the token holder to view 10 hours of streaming content on a video-sharing blockchain. For purposes here “Token” means a representation of a right. Such crypto tokens are tradable and transferrable among the various participants of the blockchain.

As used herein “cryptocurrency” is meant to refer to a digital asset designed to work as a medium of exchange. The individual coin ownership records are stored in a computerized database known as a ledger. The ledger uses strong cryptography or cryptographic signatures to secure transaction records, to control the creation of additional coins, and to verify the transfer of coin ownership. A cryptocurrency is a system that meets six conditions: 1) the system does not require a central authority; its state is maintained through distributed consensus. 2) The system keeps an overview of currency units and their ownership. 3) The system defines whether new cryptocurrency units can be created. If new cryptocurrency units can be created, the system defines the circumstances of their origin and how to determine the ownership of these units. 4) Ownership of cryptocurrency units can be proved exclusively cryptographically. 5) The system allows transactions to be performed in which ownership of the cryptographic units is changed. A transaction statement can only be issued by an entity proving the current ownership of these units. 6) If two different instructions for changing the ownership of the same cryptographic units are simultaneously entered, the system performs at most one of them.

As used herein “smart contract” is meant to refer to a computer program or transaction protocol which is intended to automatically execute, control or document relevant events and actions in accordance with the terms of a contract or agreement. A self-executing contract with the terms of the agreement between buyer and seller being directly written into lines of code. The code and the agreements exist across a distributed, decentralized blockchain network. The code controls the execution, and transactions are trackable and irreversible. Smart contracts permit trusted transactions and agreements to be carried out among disparate, anonymous parties without the need for a central authority, legal system, or external enforcement mechanism. One area of current research is the use of the blockchain for the implementation of “smart contracts”. These are computer programs designed to automate the execution of the terms of a machine-readable contract or agreement. Unlike a traditional contract which would be written in natural language, a smart contract is a machine-executable program, which comprises rules that can process inputs to produce results, which can then cause actions to be performed dependent upon those results, Examples of Bitcoin transactions are given in A Jan Reiner: Bitcoin Wallet Identity Verification Specification″. Smart contracts are particularly known from the Ethereum network, with notable explanations in Gav Wood: “Ethereum Development Tutorial. ethereum/wiki Wiki. GitHub 11, in K. Ken: “Tutorial 1: Your first contract - Ethereum Community Forum”, and in “Ethereum Frontier Guide”, version of 4 Feb. 2016. Smart contracts have advantages over equivalent conventional financial instruments, including minimizing counterparty risk, reducing settlement times, and increased transparency. UBS proposed “smart bonds” that use the bitcoin blockchain in which payment streams could hypothetically be fully automated, creating a self-paying instrument. See, “Blockchain Technology: Preparing for Change”, Accenture; Ross, Rory (2015 Sep. 12). “Smart Money: Blockchains Are the Future of the Internet”, Newsweek; Wigan, David (2015 Jun. 11). “Bitcoin technology will disrupt derivatives, says banker”, IFR Asia.

As used herein “blockchain” is meant to refer to a distributed, decentralized, public ledger. Essentially, blockchain is a chain of blocks, where the “blocks” of digital information are stored in a “chain” public database. The blocks are made up of digital pieces of information and typically have three parts: 1) Stored information about transactions like the date, time, and dollar amount. 2) Stored information about who is participating in the transaction. A unique digital signature is used to identify each participant. 3) Stored information to distinguish each block from other blocks. Each block stores a unique code called a “hash” that tells a block apart from every other block. Hashes are cryptographic codes created by special algorithms. In this document we use the term ‘blockchain’ to include all forms of electronic, computer-based, peer- to-peer, distributed ledgers. These include, but are not limited to, consensus-based blockchain and transaction-chain technologies, permissioned and un-permissioned ledgers, shared ledgers, and variations thereof. The most widely known application of blockchain technology is the Bitcoin ledger, although other blockchain implementations have been proposed and developed. While Bitcoin may be referred to herein for the purpose of convenience and illustration, it should be noted that the invention is not limited to use with the Bitcoin blockchain and alternative blockchain implementations and protocols fall within the scope of the present invention.

As used herein “record” is meant to refer to evidence of one or more interactions. A digital record can be electronic documentation of an interaction. A record can include a record identifier and record information. For example, record information can include information describing one or more interactions and/or information associated with the interactions (e.g., a digital signature). Record information can also include multiple data packets each of which include different data describing different interactions. A record identifier can be a number, title, or other data value used for identifying a record. A record identifier can be nondescript, in that it may not provide any meaningful information about the record information in the record. Examples of records include medical records, academic records, transaction records, credential issuance records, etc. In some embodiments, a record can be stored in a block of a blockchain. An individual block may include an individual record or a predetermined number of records, and a blockchain can be a series of records organized into blocks. Specific use of blockchain for records can be a pair of linked encryption keys. For example, a key pair can include a public key and a corresponding private key. In a key pair, a first key (e.g., a public key) may be used to encrypt a message, while a second key (e.g., a private key) may be used to decrypt the encrypted message. Additionally, a public key may be able to verify a digital signature created with the corresponding private key. The public key may be distributed throughout a network to allow for verification of messages signed using the corresponding private key. Public and private keys may be in any suitable format, including those based on RSA or elliptic curve cryptography (ECC). In some embodiments, a key pair may be generated using an asymmetric key pair algorithm.

As used herein “key” is meant to refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (IDES), data encryption standard (DES), advanced encryption standard (AES), etc.

As used herein “signature” is meant to refer to an electronic signature for a message or some data. A digital signature may be a numeric data value, an alphanumeric data value, or any other type of data including a graphical representation. A digital signature may be a unique data value generated from a message/data and a private key using an encrypting algorithm. In some embodiments, a validation algorithm employing a public key may be used to verify the signature.

In one configuration a method of automatically tokenizing property rights to convert to a crypto currency with an equity conversion computer having software executing thereon and having access to a network is provided, the equity conversion computer performing the following steps: presenting a property information intake page to a user computer associated with a user account including an electronic wallet, the property information intake page comprising a plurality of property information fields, and saving property information input into the plurality of property information fields on the storage in a first format. The equity conversion computer also performs the following steps: automatically generating a property profile based on the property information saved on the storage and transmitting the property profile to the user computer, generating documents granting property rights associated with the property profile to a governing entity, and generating recordation documents for recording the property rights with a government recordation computer. Finally, the equity conversion computer performs the following steps: generating a smart contract associated with the property rights, generating tokens associated with the smart contract, recording the smart contract in blockchain, and transferring the tokens to a wallet saved on the storage of the user computer.

In another configuration a system for automatically tokenizing property rights to convert to a crypto currency with a computer having access to a network is provided, the system comprising an equity conversion computer having a storage and coupled to a network, and property intake software executing on the equity conversion computer presenting a property information intake page to a user computer via the network and associated with a user account having an electronic wallet, the property information intake page comprising a plurality of property information fields. The system is provided such that the property intake software saves property information input into the plurality of property information fields on the storage in a first format and the property intake software automatically generates a property profile based on the property information saved on the storage and transmitting the property profile to the user computer. The system is further comprising property conversion software executing on the equity conversion computer generating documents granting property rights associated with the property profile to a governing entity. The system is provided such that the property conversion software generates recordation documents for recording the property rights with a government recordation computer, and the property conversion software generates a smart contract associated with the property rights. The system is further provided such that the property conversion software generates tokens associated with the smart contract to generate tokenized property rights, the property conversion software records the smart contract in blockchain, and the property conversion software transfers the tokens to a wallet saved on the storage of the user computer.

Other objects of the invention and its features and advantages will become more apparent from consideration of the following drawings and accompanying detailed description.

### BRIEF DESCRIPTION OF THE DRAWINGS

FIG. 1 is a block diagram of the system for automatically tokenizing property rights to convert to a crypto currency.

FIG. 2 is a functional block diagram illustrating the process of tokenizing property rights to convert to a crypto currency according to the system of FIG. 1.

FIG. 3A is a flow diagram of a method for automatically tokenizing property rights to convert to a crypto currency according to the system of FIG. 1.

FIG. 3B is a flow diagram of a method for automatically tokenizing property rights to convert to a crypto currency according to the system of FIG. 1.

FIG. 4 is an embodiment of the invention utilizing property rights according to the system of FIG. 1.

FIG. 5 is an embodiment of the invention utilizing property rights according to the system of FIG. 4.

FIG. 6 is an embodiment of the invention utilizing property rights according to the system of FIG. 4.

FIGS. 7-13 are embodiments of the graphical user interface for the property intake software according to the system of FIG. 1.

FIGS. 14-19 are embodiments of the graphical user interface for the property conversion software according to the system of FIG. 1.

FIG. 20 is an embodiment of the profile of the property generated by the property intake software according to the system of FIGS. 7-13.

### DETAILED DESCRIPTION OF THE INVENTION

Referring now to the drawings, wherein like reference numerals designate corresponding structure throughout the views.

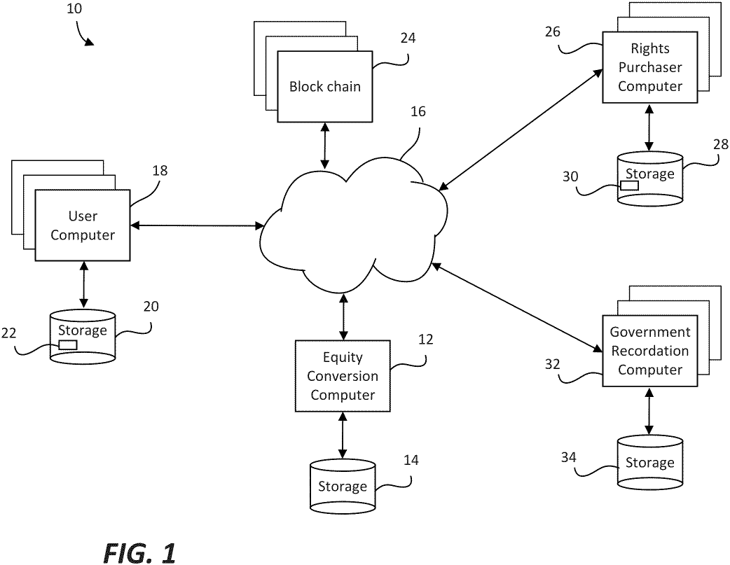

FIG. 1 is a block diagram showing the system 10 for automatically tokenizing property rights to convert to a crypto currency. The system comprises an equity conversion computer 12 that has a storage 14 and is connected to a network 16, which may comprise the internet. Equity conversion computer will have software executing thereon comprising several software modules that may comprise programs.

Also illustrated in FIG. 1 is user computer 18, which has a storage 20 accessible thereto. The user computer allows a user to access the equity conversion computer 12 via the network 16 connection. Additionally, the storage 20 may have user information stored thereon, including property information the user is looking to tokenize as well as the user’s electronic wallet 22. It is contemplated that many user computers may access the equity conversion computer 12, which is why multiple computers are illustrated.

Also shown in FIG. 1 is blockchain 24, which is accessible to the equity conversion computer 12 via the network 16 connection. As blockchain 24 is understood by those of skill in the art, it will not be extensively described herein.

Rights purchaser computer 26 having a storage 28 is further illustrated in FIG. 1. The storage 28 further illustrates an electronic wallet 22 associated with a user of the rights purchaser computer 26. Again, it is contemplated that many different user’s could access equity conversion computer 12 via network connection 16 which is why multiple computers are illustrated.

Finally, a government recordation computer 32 having a storage 34 is shown in FIG. 1 and is accessible by equity conversion computer 12 via network connection 16. It is contemplated that multiple different government recordation computer may need to be accessed by equity conversion computer 12, which is why multiple computers are illustrated.

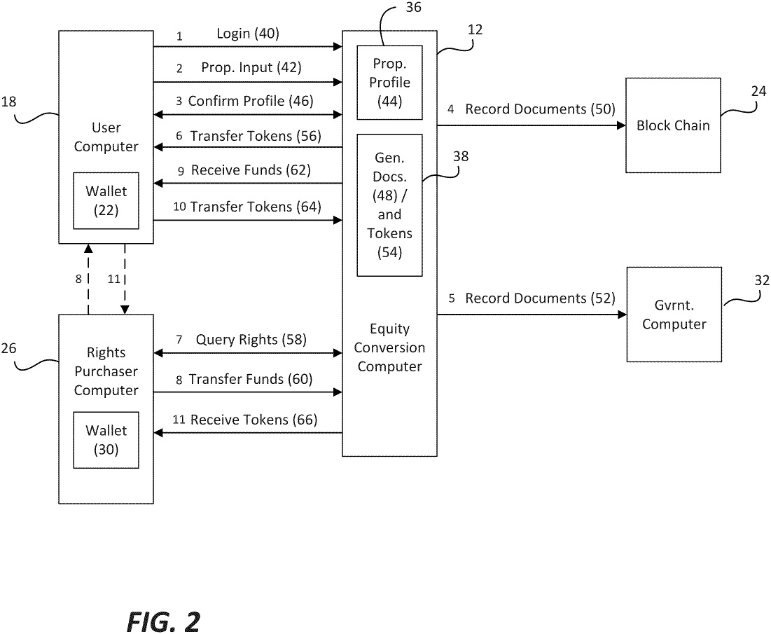

FIG. 2 is a functional block diagram of the system 10 for automatically tokenizing property rights to convert to a crypto currency. The functional block diagram lists a series of steps that the system may process. It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

Initially a user may login 40 accessing the equity conversion computer 12 using user computer 18. The login procedure may comprise any number of secure methods to ensure that only the user is able to access the equity conversion computer 12 with the user account.

Once the user has logged in, the user may access a variety of property information fields in one or more screens to input property information 42 via property intake software 36 executing on equity conversion computer 12. This process may include the entry of a substantial amount of information relating to the property including, but not limited to, the address of the property, the acreage and configuration of the property or properties, the type of access to the property (e.g., paved road, gravel road, dirt road, number of lanes, easements, etc.), any studies and / or reports that have been carried out with respect to the property (e.g., studies relating to oil or gas reserves on the property, mineral deposits, depth of the reserves / deposits, the soil composition, the oil / gas / mineral reserves on nearby properties, etc.), any or all improvements on the property (e.g., structures, fields, barns, drainage, wells, utilities, etc.), a detailed description of the improvements including photographs of the property and the improvements along with construction or government records relating to the improvements, a description of any and all bodies of water on the property including access and whether navigable, a description of any and all rivers, creeks and streams that run in / out / across the property, the depth of any wells on the property, and so on. It should be noted that this listing is only provided to illustrate some of the information that can be input into the system and is not meant to be limiting.

Once the property information is entered into the equity conversion computer 12 and saved on storage 14, the property intake software 36 then generates a property profile 44. The user may then confirm 46 that the property profile is accurate and complete based on the rights the user would like to tokenize. Also illustrated in FIG. 2 is property conversion software 38, which uses the property profile 44 to generate documents 48. These documents may comprise a smart contact, and a legal contract subjecting the property to a governing entity. As stated previously, the governing entity may comprise for instance, a HOA or a POA that outlines property rights that may be tokenized. Once the smart contract is generated, it may be saved / recorded 50 to blockchain 24.

Additionally, the legal contract that places the property under the governing entity may be filed with government computer 32. A unique function of the property conversion software 38 is that it creates the governing entity documents in accordance with the property right associated with the property, the system files, and the governing entity docs. The property conversion software 38 can also identify additional rights that may be dormant and include them in the documents created for the HOA / POA Governing Entity.

The government computer 32 may comprise one or more computers depending on the documents that need to be filed. For example, if a governing entity already exists in the state in which the property is located, then the documents need only place the property under the auspices of the governing entity and can be filed with the county recorder’s office. If, however, an entity does not exist in the state, then the documents may comprise the creation of a governing entity and filing of those documents may occur to properly form the entity, after which documents placing the property under the auspices of the newly formed governing entity can occur. In any event, the property conversion software 38 can record the documents 52 with the appropriate government computer 32.

The property conversion software 38 will also generate tokens 54 that are associated with the property rights that have been tokenized. These tokens can then be transferred 56 and saved in the user’s electronic wallet 22. As was previously stated, the user’s electronic wallet 22 may comprise Anti-money Laundering and Counter-Terrorism Financing (AML/CFT) information. AML/CFT compliance may vary by jurisdiction, but can be generalized into two main groups of measures: 1) (Electronic) Know Your Customer (eKYC) is the obligatory (remote) verification of each new customer identity at sign-up, and may include further probing of the customer over time if the user wants to unlock new transaction limits or store more funds on an account; and 2) Screenings that are based on cross checking the customer’s identity against sanctions lists of individuals or entities known to be associated with criminal activities, terrorist funding or even being politically exposed (thus highly susceptible to corruption and money-laundering activities). The goal of the KYC process is to identify the customer of the e-wallet application and therefore to be able to validate customer-related risks.

At this point, the property conversion software 38 can present the tokens on the equity conversion computer 12 to the public for the purpose of allowing the public to purchase the tokens with the associated property rights. At this point rights purchaser computer 26 is illustrated querying the property rights 58. Once the purchaser using the property rights computer 26 identifies property rights they want to obtain, they can contact the property owner to negotiate a sale price for the tokens in the user’s wallet 22. Once this is decided, the purchaser can transfer funds 60 to the equity conversion computer 12, which in turn can then be received 62 by the user computer 18 and saved to the user’s wallet 22. The equity conversion computer 12 can also transfer the tokens 64 out of the user’s wallet 22, which tokens will be received 66 by the rights purchaser computer 26 to be saved in the purchaser’s wallet 30.

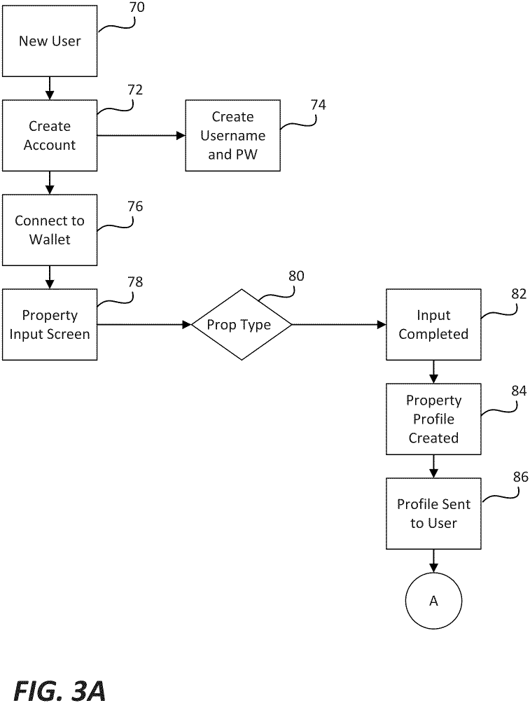

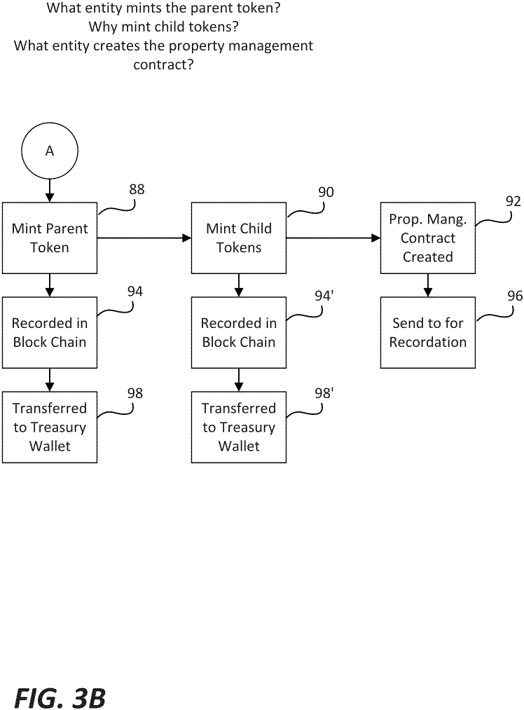

Referring now to FIGS. 3A and 3B, a new user 70 accesses the equity conversion computer 12 to create a user account 72. The process of creating a login can include creating a username and password 74 and can further include additional identification methods such as two-factor identification and the like.

Once the user account is created, the equity conversion computer 12 can connect 76 to the user’s electronic wallet. As described previously, this allows the system to identify the person associated with the electronic wallet 22. Alternatively, if the user does not have an electronic wallet 22, the system can generate an electronic wallet 22 to be associated with the user. From here, the user may be presented with one or more property input screen 78 that may include a plurality of information fields where the user can input relevant information about the property and the property rights to be conveyed including for example, a property type 80.

Once the user has input all the relevant information into the various fields, the software will save the data into a format that the system can use, and the input is complete 82. The property input software can then generate a property profile 84 that includes the information about the property that the user input into the system as well as other information the system may have that may be useful in determining the value of the property rights the user is looking to tokenize. This information could include the value of similar rights in properties near the current property, and / or could include any reports or studies relating to oil / gas / minerals / carbon sink and the like in similar properties or properties adjacent to or close by the current property. In one configuration, the system utilizes the Mongo Database (MongoDB), which is a nonrelational database management system (DBMS) that uses flexible documents instead of tables and rows to process and store various forms of data. As a NoSQL solution, MongoDB does not require a relational database management system, so it provides an elastic data storage model that enables easy storing and querying multivariate data types.

Once the property profile is completed, it is sent to the user 86 for the user to review and adjust if needed. If the property profile is complete and accurate, then the user can confirm this with the equity conversion computer 12.

Referring now to FIG. 3B, which is a continuation from FIG. 3A, the property conversion software can then mint or generate a parent token 88 for the rights to be conveyed associated with the parent token. A parent token can be any token that conveys a broad property right, such as, a minerals rights, or a right of occupancy on the property or a right to digitally display the property.

Once the parent tokens are generated, the property conversion software can then generate child tokens, which reflect a subset of rights associated with the parent tokens. In the above example, the child tokens could comprise the right to mine Lithium as a subset of the mineral rights, or it could be a right of occupancy for a period of three months, or it may comprise a right to digitally display the property for a limited time or on a specific platform. It will be understood by those of skill in the art that a smart contract is generated at the time the various tokens are minted / generated.

At this point, a property management contract is created 92 that places the property under the control of a governing entity as has been previously discuss in connection with FIGS. 1 and 2. The property management contract is then sent for recordation 96 as previously discussed.

The parent and child tokens can then be listed on the equity conversion computer 12 for public viewing. It should be noted that not all of the minted tokens need to be listed. For example, the seller may only want to offer child tokens for sale. Additionally, the smart contracts for the parent and child tokens as well as any other necessary information is recorded in Blockchain 94, 94′. Finally, the parent tokens and child tokens are transferred to the user’s electronic wallet 98, 98′.

It should be noted that the recordation of the property rights with the county clerk’s office makes it possible to cross verify that the documents recorded on the blockchain are valid, giving the purchaser a high degree of confidence. The system described in connection with FIGS. 1-3B bridges centralized and decentralized system because the information is validated and shared with each recording entity: blockchain and county recorder’s office.

Another example of how a homeowner can utilize their home as a method for generating currency is further described. A residential real property is purchased. The residential real property owner desires to utilize cryptocurrency. The residential real property owner obtains market comparable studies to determine the amount of equity available for crypto collateralization. Crypto collateralization is stated as a percentage of the real property with a current dollar value, or crypto equity position. The crypto equity position is determined at the crypto collateralization and is reflective of the percentage of real property utilized for the purpose of crypto collateralization. Upon authorization from the governing entity (or a governing body which possesses the power to impose liens or other legal encumbrances on the property) and the property owner, the issuing entity creates: a blockchain title registry, cryptocurrency, account, smart contract, blockchain, and proper title documents for recordation with the local authority. Cryptocurrency coins or tokens are assigned at a valued increment against the current equity value in the subject property. The governing entity and homeowner authorize the issuing entity to create and release a stated amount of cryptocurrency for sale. The issuing entity, on behalf of the homeowner, sells the cryptocurrency and places the proceeds from the sale into an escrow account for the residential real property owner’s benefit.

Alternatively, a nonresidential real property may be used in like manner. The nonresidential property owner obtains market comparisons to determine the amount of equity available for crypto collateralization. The crypto collateralization is stated as a percentage of the real property with a current dollar value, called a crypto-equity position. The crypto-equity position is determined at the time the crypto collateralization, is initiated, and is reflective of the percentage of real property utilized for the purpose of crypto collateralization. Upon authorization by a governing entity and the nonresidential real property owner, the issuing entity creates: a blockchain title registry; a crypto currency account; a smart contract, blockchain, and proper title documents for recordation with the local authority. Cryptocurrency coins or tokens are assigned at a valued increment against the current equity value in the subject property. The governing entity and nonresidential property owner authorize the issuing entity to create and release an agreed upon amount of cryptocurrency for sale. The issuing entity sells the cryptocurrency and places the proceeds from the sale into an account for the real property owner’s benefit.

Still further, in another example a real property owner wants to allocate the use of the surface or subsurface rights in the real property. The individual desires to utilize crypto currency for the purpose of allocating surface or subsurface rights. The individual obtains market comparisons to determine the amount of equity available for crypto collateralization. The crypto collateralization is stated as a percentage of the real property with a current dollar value, called a crypto-equity position. The crypto-equity position is determined at the time the crypto collateralization is initiated and is reflective of the percentage of real property utilized for the purpose of crypto collateralization. Upon authorization from a governing entity and the income property owner, the issuing entity creates: a blockchain title registry; a cryptocurrency account; a smart contract, Blockchain, escrow account, and proper title documents for recordation with the local authority. Crypto currency coins or tokens are assigned at a valued increment against the current equity value in the subject property. The governing entity and real property owner authorize the issuing entity to create and release an agreed upon amount of crypto currency for sale. The issuing entity sells the crypto currency and places the proceeds from the sale into an escrow account for the purchase of the real property. The purchasers of the crypto currency own certain rights associated with the use of the surface or subsurface of the real property.

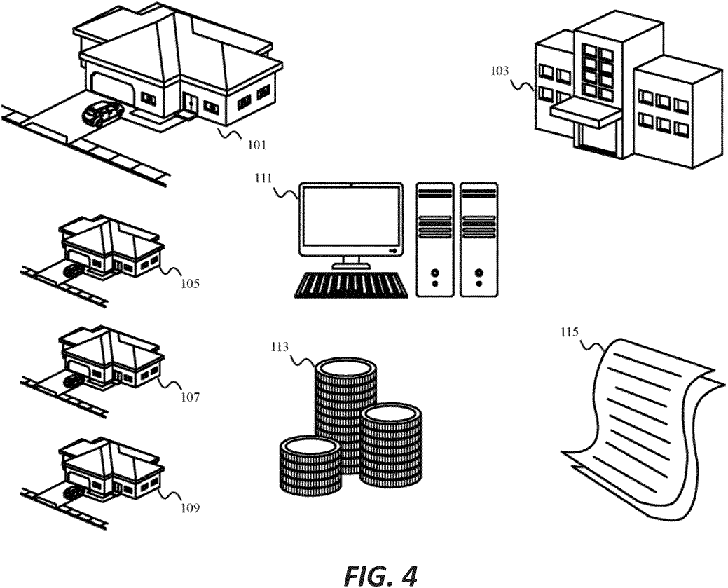

Referring to FIG. 4 one example of how a homeowner can utilize their home as a method for generating currency is presented. A residential real property 101 is purchased. The homeowner obtains market comparable studies, for example obtaining the value of homes 105, 107, and 109, to determine the amount of equity available for crypto collateralization. These market studies consider the comparable aspects of each home. Aspects such as: the size of each of the homes, the location of each of the homes, the age of each of the homes, the size of the land attached to each of the homes, and so on. The studies endeavor to quantify these aspects and define a picture of the value of the new homeowner’s real property. Once the studies have been carried out, a value is assigned to the real property. When the real property has been assigned a value, a governing entity 103 presents this to the homeowner. The homeowner decides the amount of currency they wish to obtain. The governing entity 103 submits the value and the request for collateralization to the issuing entity, which begins the currency issue process. The amount the homeowners wishes to obtain in crypto collateralization is stated as a percentage of the real property with a current dollar value. The crypto-equity position is determined at the crypto collateralization and is reflective of the percentage of real property utilized for the purpose of crypto collateralization. The issuing entity creates: block chain title registry 111, crypto currency 113, account, smart contract 115, block chain and smart contract hyper ledger. Crypto currency coins 113 are assigned valued increment against the current equity value in the subject property, essentially upon assignment, each cryptocurrency coin 113 is worth One Dollar (USD 1.00) of the assigned value of the real property. The homeowner and the governing entity 103 authorize the issuing entity to release a stated amount of crypto currency for sale. The issuing entity mediates the sale of the crypto currency 113 and places the proceeds from the sale into an escrow account for the residential real property owner’s benefit.

In some embodiments, the equity become a liquid asset for the homeowner, where the homeowner can use the amount of equity for whatever they desire while forgoing the actual ownership of that equity. When a homeowner decides to place a residential property up for collateralization the governing entity initiates the protocol for the collateralization process. This protocol imports all the details of the property and the current encumbrances on the property, to the issuing entity. Once all of the data of the property is entered into the protocol, the property is collateralized with crypto currency and each coin of the cryptocurrency is valued at approximately one U.S. dollar. For example, a property that is valued at $500,000 would issue 500,000 coins. The coins are placed in an auction. Those who want to buy the coins can bid on them in the auction. The protocol will sell the coins at the auction. Even if there is a mortgage on the property, the coins will sell for the full value of the equity in the property. The proceeds from the sale will be used to pay off the mortgage, and the amount of equity owned by the property owner will be paid to the property owner. The property owner will then have the amount of their equity to use in whatever manner they wish. The homeowner will still maintain the right to occupancy and may have a payment to the issuing entity to maintain that right to occupancy.

A monetary event, such as sale of the property will result in a cashing out of the coins related to that property. All purchased coins related to that property will be paid at the current value of the coins purchased.

In some embodiments, the governing entity is an HOA, and the issuing entity is an organization developed for the issuing and oversight of the cryptocurrency. In other embodiments, the governing and issuing entities are the same company. In many embodiments where the governing and issuing entities are the same entry, that entity is an HOA.

In an alternative embodiment, the currency is a currency other than crypto currency. A residential real property 101 is purchased. The homeowner decides to utilize asset backed currency. The homeowner obtains market comparable studies, for example obtaining the value of homes 105, 107, and 109 to determine the amount of equity available in the property. These market studies consider the comparable aspects of each home as previously described. Once the studies have been carried out, a value is assigned to the real property. When the real property has been assigned a value, a governing entity 103 presents this to the homeowner. The homeowner decides the amount of currency they wish to obtain. The governing entity 103 submits the value and the request for currency to the issuing entity, which begins the currency issue process. The amount the homeowners wishes to obtain in currency is stated as a percentage of the real property with a current dollar value. The equity position is determined at the time of the valuation and the minting of the currency and is reflective of the percentage of real property utilized for the purpose of currency creation. The issuing entity creates title registry 111, currency 113, account, contract 115. Currency such as coins 113 are assigned valued increment against the current equity value in the subject property, essentially upon assignment, each currency coin 113 is worth One Dollar (UDS $1.00) of the assigned value of the real property. The homeowner and the governing entity 103 authorize the issuing entity to release a stated amount of currency for sale. The issuing entity mediates the sale of the currency 113 and places the proceeds from the sale into an escrow account for the residential real property owner’s benefit.

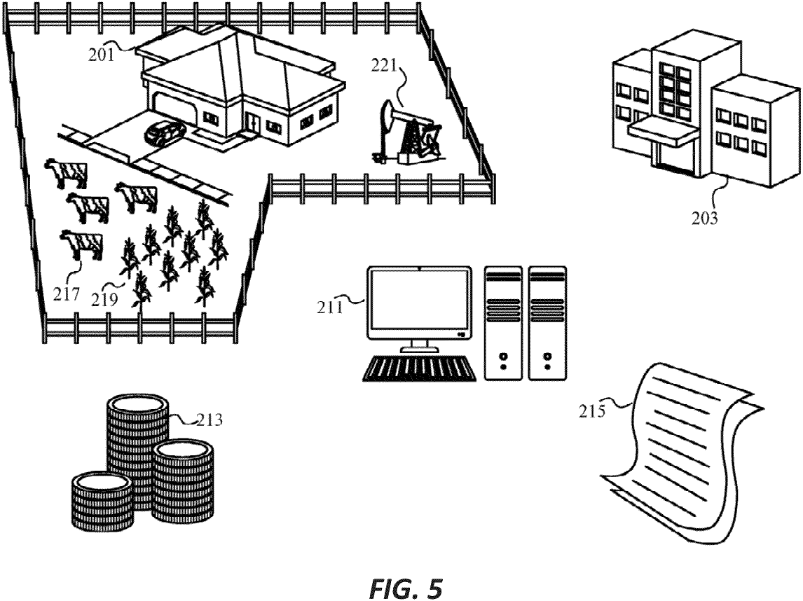

Referring to FIG. 5, an example of how a homeowner can utilize their home as a method for generating currency is presented. A residential real property 201 is purchased. The new homeowner decides to utilize crypto currency to monetize their rights in the real property. Rights in property include surface rights. Surface rights allow the homeowner to utilize the surface of their property. Often the use of surface rights is utilized through agriculture. The use can be growing crops, raising livestock, or both. In many instances surface rights are leased to others. A homeowner can decide to utilize these surface rights through crypto currency collateralization. The property owner obtains market comparable studies, to determine the amount of equity available for crypto collateralization. These market studies consider the comparable aspects of the surface rights. Aspects such as: the size of each piece of land; the location of each piece of land; the soil composition of each piece of land; the likely use of the land; and the value of the use to which the land will be put. For example, the land could be in a location that is well suited to growing corn 219. The market study would then focus on corn for the comparison. The comparison would specify the market rate for the sale of corn, the cost to grow the corn, and possible other uses such as entertainment like corn mazes. Alternatively, the land might be better suited to raising cattle 217. The market studies would then focus on cattle raising. The studies endeavor to quantify these aspects and define a picture of the value of the homeowner’s surface rights. Once the studies have been carried out a value is assigned to the surface rights. When the surface rights have been assigned a value, a governing entity 203 presents this to the homeowner. The homeowner decides the amount of currency they wish to obtain. The issuing entity begins the currency issue process. The amount the homeowners wishes to obtain in Crypto collateralization is stated as a percentage of the surface rights with a current dollar value. The crypto-equity position is determined at the crypto collateralization and is reflective of the percentage of surface rights utilized for the purpose of crypto collateralization. The issuing entity creates: block chain title registry 211, crypto currency 213, account, smart contract 215, block chain and smart contract hyper ledger. Crypto currency coins 213 are assigned at a specific stated value against the current equity value in the surface rights. Essentially each cryptocurrency coin 213 is worth approximately one dollar (USD $1.00) of the assigned value of the surface rights. The homeowner and a governing entity authorize the issuing entity to release a stated amount of cryptocurrency for sale. The issuing entity lists the cryptocurrency 213 for sale and places the proceeds from the sale into an escrow account for the real property owner benefit.

In some embodiments, the property owner desires the surface rights become a liquid asset for the property owner, where the property owner can use the value of the surface rights for whatever they while forgoing the actual ownership of those rights. When a property owner decides to place the surface rights of a property up for collateralization the governing entity initiates the protocol for the collateralization process. This protocol imports all the details of the property and the current encumbrances on the property, to the issuing entity. Once all the details of the property are entered into the protocol run by the issuing entity, the surface rights of the property are collateralized with crypto currency and each coin of the crypto currency is valued at approximately one U.S. dollar. For example, a property with surface rights that are valued at $1,000,000.00 would issue 1,000,000 coins. The coins are placed in an auction. Those who want to buy the coins can bid on them in the auction. The protocol will sell the coins at the auction. Even if there is a mortgage on the property, the coins will sell for the full value of the surface rights in the property. The proceeds from the sale will be used to pay off the mortgage, and the amount left over after paying the mortgage will be paid to the property owner. The property owner will then have the amount from the collateralization of the surface rights minus the cost of the mortgage to use in whatever manner they wish. The property owner will still maintain other rights to the property.

A monetary event, such as sale of the property will result in a cashing out of the coins related to that property. All purchased coins related to that property will be paid at the current value of the coins purchased.

Alternatively, the real property owner decides to utilize crypto currency for subsurface rights. Subsurface rights allow the homeowner to utilize what is found under the surface of their property, which includes mineral, oil and gas rights. In many instances subsurface rights are leased to others. A real property owner can decide to utilize these subsurface rights through crypto currency collateralization. The property owner can establish a valuation of the subsurface rights through one of several methods. In one embodiment, the property owner obtains market comparable studies, to determine the amount of equity available for crypto collateralization. These market studies consider the comparable aspects of the subsurface rights. Aspects such as: the size of each piece of land; the location of each piece of land; the soil composition of each piece of land; the likely use of the land; and the value of the use to which the land will be put. For example, the land could be in a location that is known to have deposits of coltan, which contains tantalum. Tantalum is used in the production of capacitors, such as those found in cell phones, computers, and cameras. The market study would then focus on coltan for the comparison. The comparison would specify the market rate for the sale of coltan, the cost to extract the coltan, and possible other uses. Alternatively, the land might be better suited to oil drilling 221. The market studies would then focus on oil. The studies endeavor to quantify these aspects and define a picture of the value of the new homeowner’s subsurface rights. Once the studies have been carried out, a value is assigned to the subsurface rights. Particularly with respect to oil drilling 221, a different study such as a well size study, could be utilized. These studies may use technology to determine the size of the well and approximate the amount of oil in the well. These well size studies will then assign a value to the subsurface oil rights. When the subsurface rights have been assigned a value, the governing entity presents this to the real property owner. The real property owner decides the amount of currency they wish to obtain. The issuing entity begins the currency issue process. The amount the real property owner wishes to obtain in crypto collateralization is stated as a percentage of the subsurface rights with a current dollar value. The crypto equity position is determined at the crypto collateralization and is reflective of the percentage of subsurface rights utilized for the purpose of crypto collateralization. The governing entity and property owner authorize the issuing entity to create block chain title registry 211, crypto currency 213, account, smart contract 215, block chain and smart contract hyper ledger. Crypto currency coins 213 are assigned a specific stated value against the current equity value in the subsurface rights, essentially, upon collateralization, each cryptocurrency coin 213 is worth approximately one dollar ($1.00) of the assigned value of the subsurface rights. The real property owner and the governing entity 203 authorizes the issuing entity to release a stated amount of cryptocurrency for sale. The issuing entity is then authorized to sell the cryptocurrency 213 and places the proceeds from the sale into an escrow account for the real property owner’s benefit.

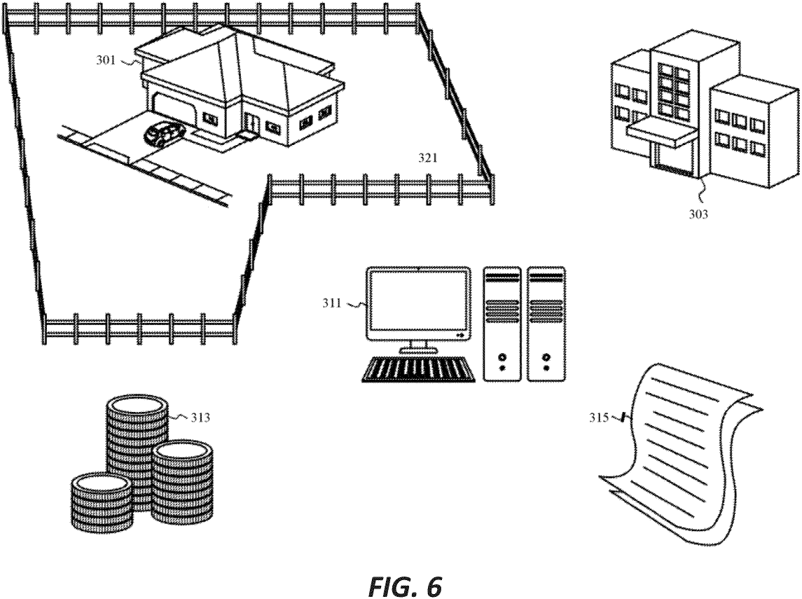

Referring to FIG. 6, the homeowner decides to utilize cryptocurrency for contractual rights. Contractual rights allow the homeowner to utilize others to perform services on the real property, which includes painting, maintenance, improvements, development, or marketing the real property for sale. In many instances contractual rights are granted to other vendors who manage the property. A homeowner can decide to utilize these rights through cryptocurrency collateralization.

The homeowner can establish a valuation of the contractual rights through one of several methods. In one embodiment, the property owner obtains market comparable studies, to determine the amount of equity in the contractual rights available for crypto collateralization. These market studies consider the comparable aspects of the contractual rights. Aspects such as: the predominant nature of use of the real property; the location of the real property; the amount of improvement to be done to the real property; the likely value of the improved real property; and the value of the services of a real estate marketing agent. For example, the land could be raw land which is in a good location for development. The market study would then focus on other developments for comparison. The comparison would specify the market rate for the sale of developed land, the cost to develop the land, and possible other uses for the land. Alternatively, the land might be better suited to be set aside for environmental easements. The market studies would then focus on potential tax credits and resale value. The studies endeavor to quantify these aspects and define a picture of the value of the homeowner’s contractual rights.

Once the studies have been carried out, a value is assigned to the different contractual rights as it pertains to the use of the property. Particularly with respect to environmental easement 321 a different study such as potential tax credits or resale value could be utilized. These studies could be based on tax codes or prior resale values for land with environmental designations. These studies will then assign to the contractual rights a value for each such right. When the contractual rights have been assigned a value, the governing entity 303 presents this to the property owner. The property owner decides the amount of currency they wish to obtain. The governing entity and real property owner authorize the issuing entity to begin the currency issue process. The amount the homeowner wishes to obtain in crypto collateralization is stated as a percentage of the contractual rights with a current dollar value. The crypto equity position is determined at the crypto collateralization and is reflective of the percentage of contractual rights utilized for the purpose of crypto collateralization. The homeowner and the governing entity authorize the issuing entity to create: blockchain title registry 311, crypto currency 313, account, smart contract 315, blockchain and smart contract hyper ledger. Cryptocurrency coins 313 are assigned a specific stated value against the current equity value in the contractual rights, essentially, upon collateralization, each crypto currency coin 313 is worth one dollar (USD $1.00) of the assigned value of the contractual rights. The real property owner and the governing body of the housing development 303 authorize the issuing entity to release a stated amount of crypto currency for sale. The issuing entity is then authorized to sell the cryptocurrency 313 and places the proceeds from the sale into an escrow account for the real property owner’s benefit.

The use of the present system and methods are not limited to real estate and land options. The same system can be applied to other forms of property such as an automobile, (e.g., a high-end sport car, an RV, a camper van, or other automobile), or a boat, or a piece of artwork, or intellectual property (e.g., patents, trademarks, copyrights, or portfolios of each).

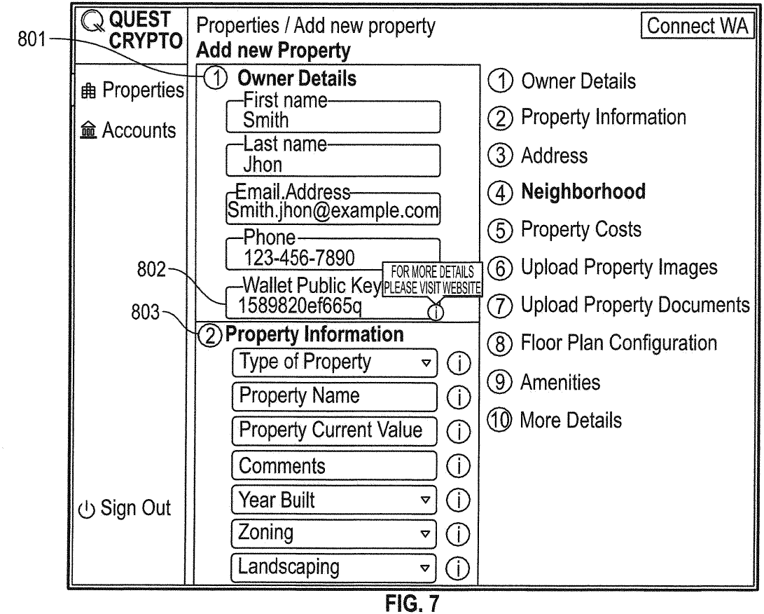

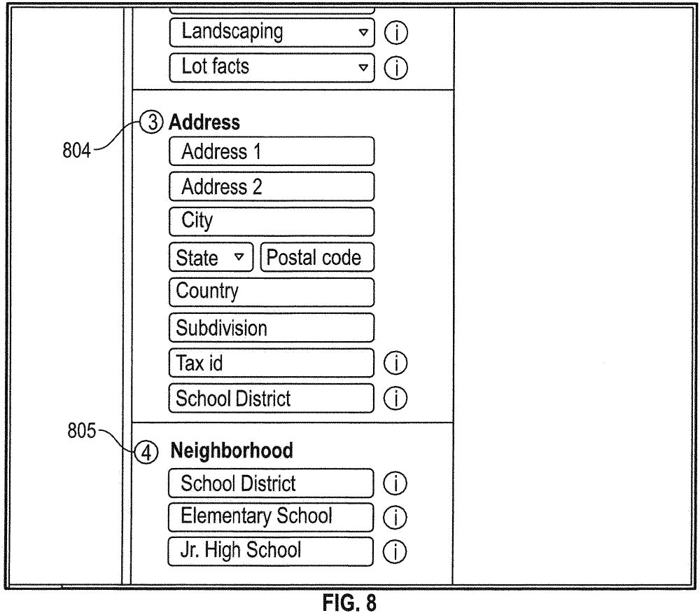

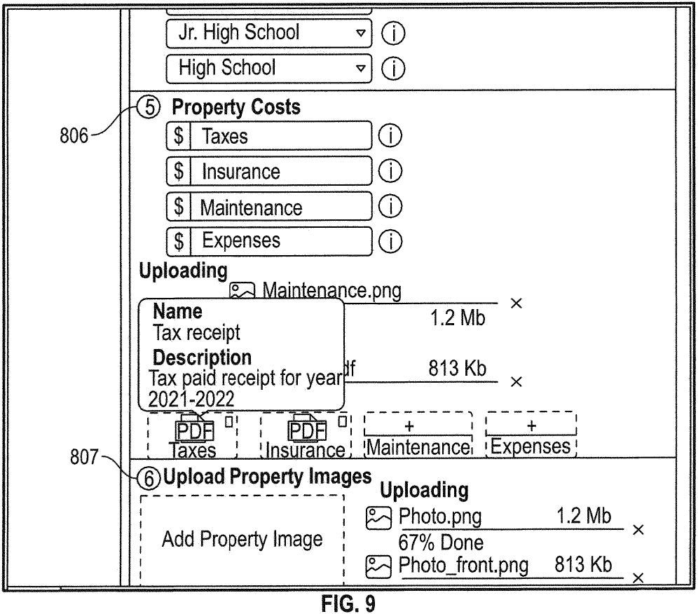

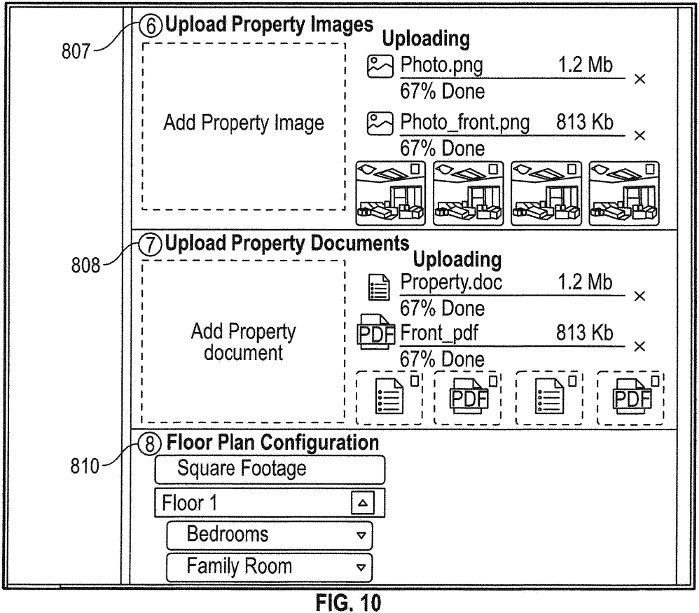

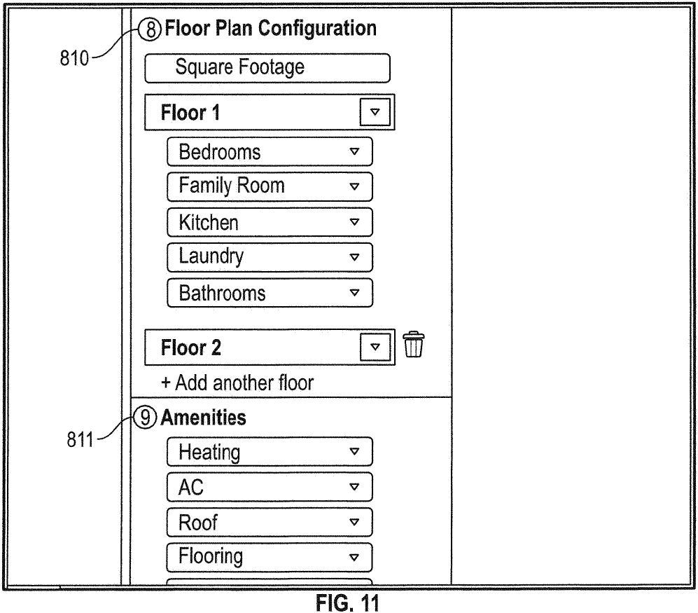

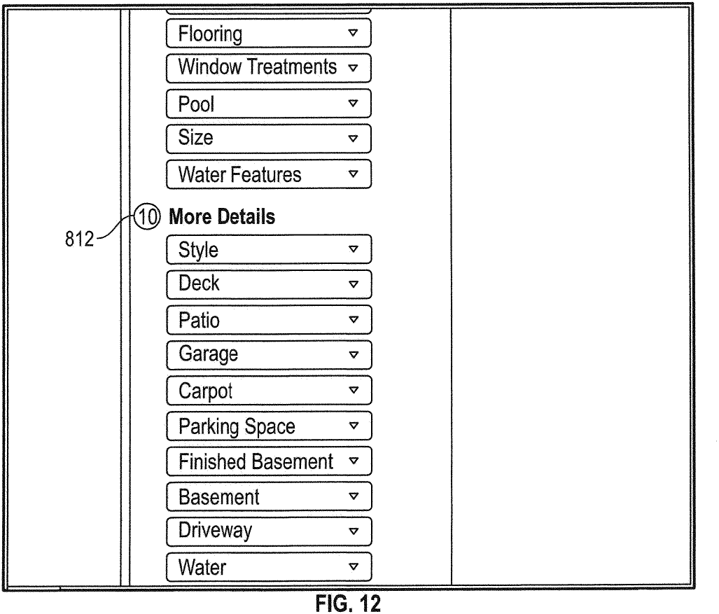

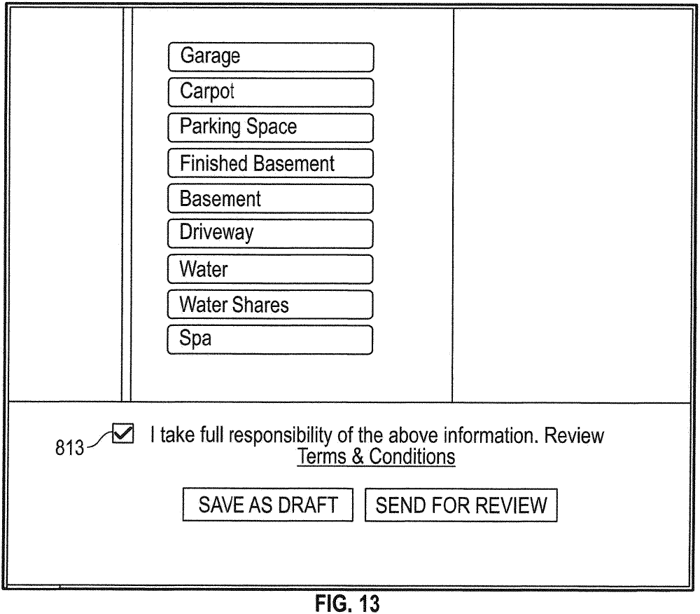

Referring to FIGS. 7-13, webpages are displayed by the property intake software 36. There are various fields illustrated that pertain to the property, such as owner details 801, including their wallet public key 802, property information 803, address information 804, neighborhood information 805, property costs 806, upload property images 807, upload property documents 808, floor plan configuration 810, amenities 811, more details 812, and user confirmation 813. The above is not inclusive of the information required, it is just an example of one configuration for the system.

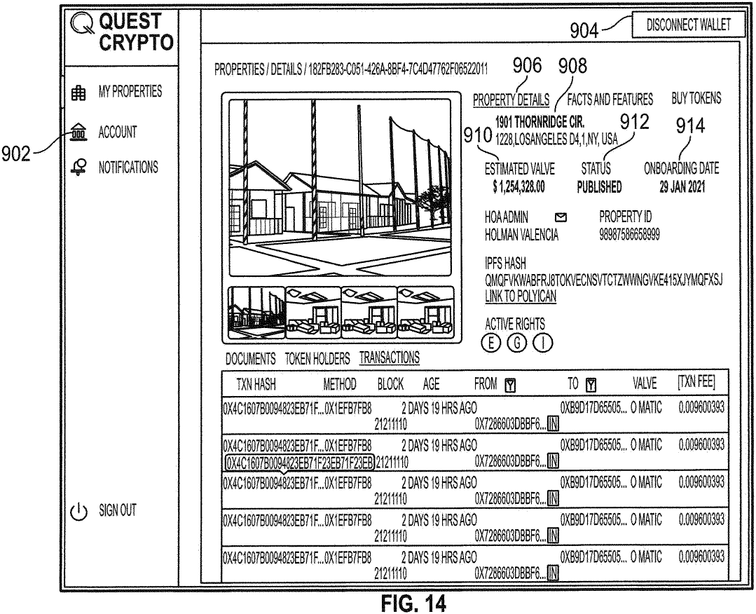

Referring to FIGS. 14-19, the property conversion software 38 shows a view of an account 902 including a property associated with a user’s wallet 22 and an interface to disconnect the wallet 904.

FIG. 14 shows property details 906, which may include, for example, the address of the property 908, the estimated value 910, the status of the property 912, an onboarding date 914, along with other information.

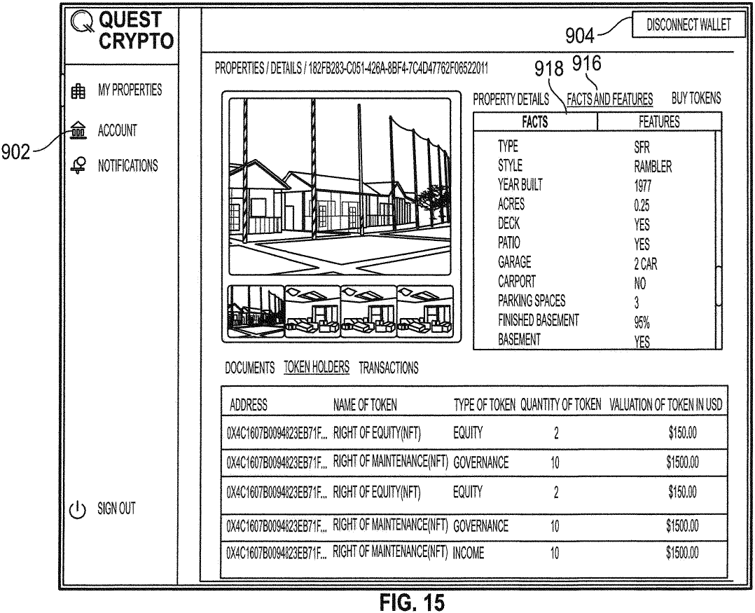

FIG. 15 shows facts and features 916, where the facts 918 tab is selected. The facts may include, for example, the type of property, the style, the year built, the acreage, if the property includes a deck or patio or garage or carport along with a description thereof, the number of parking spaces, whether there is a basement and if it is finished.

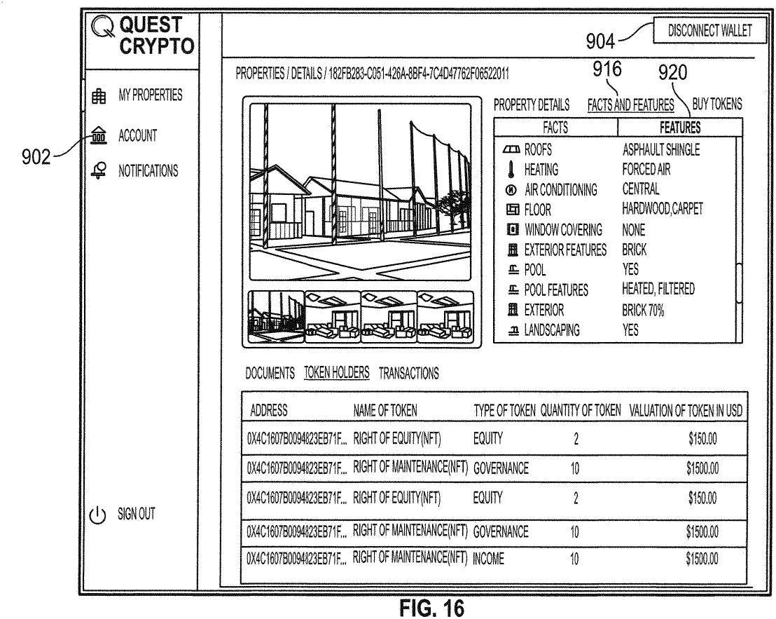

FIG. 16 shows facts and features 916, where the features 920 tab is selected. The features may include, for example, the type of roof, the type of heating, the type of air conditioning, the type of flooring, the type of window coverings (if any), the exterior features, whether there is a pool, whether there is landscaping, and so on.

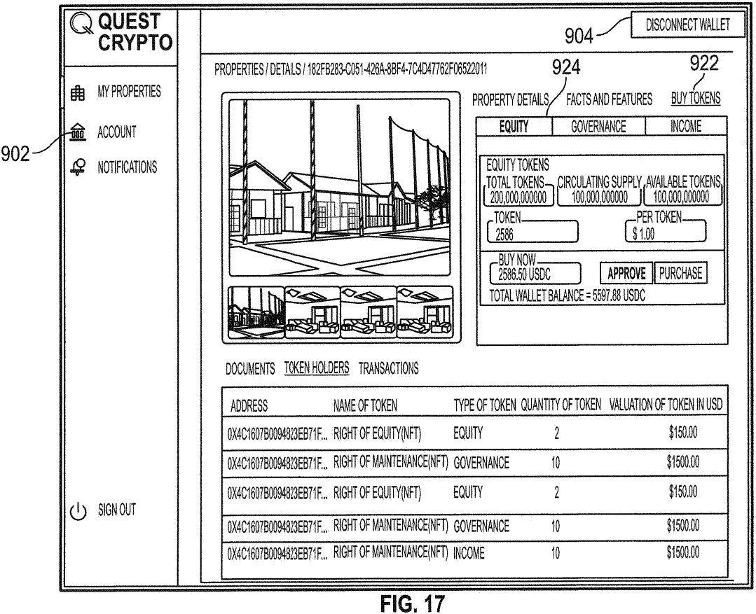

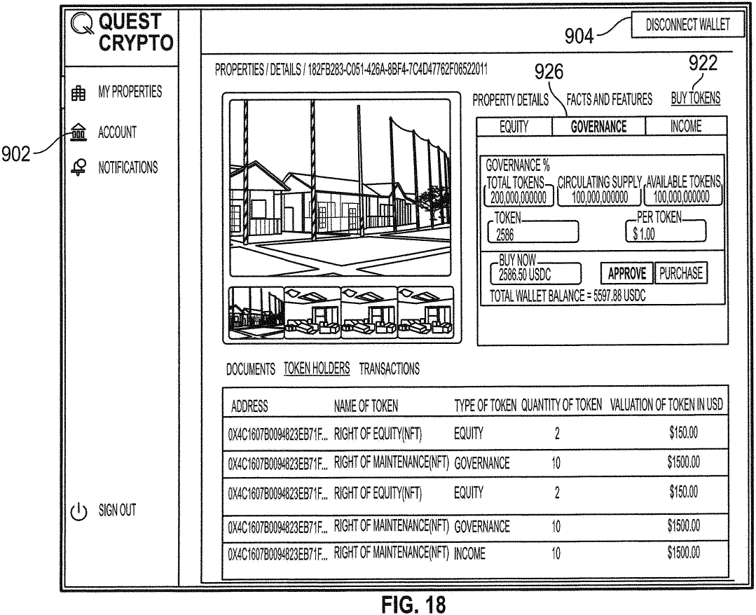

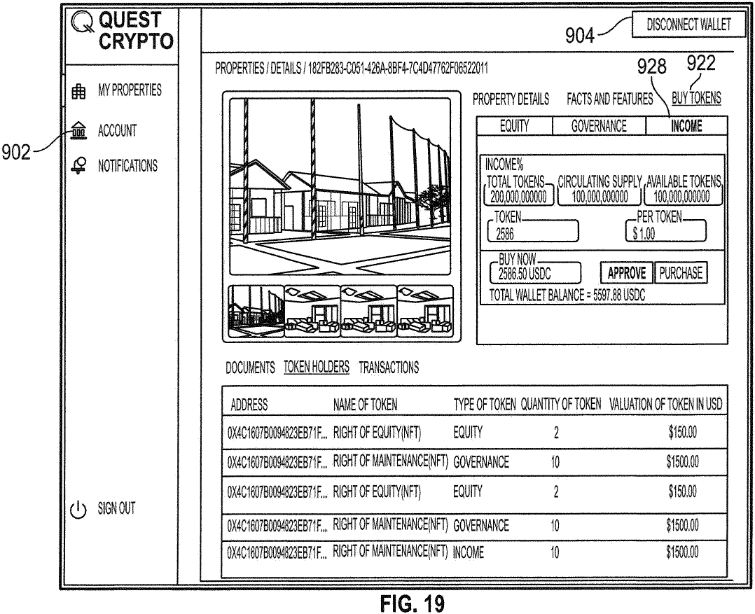

FIG. 17 shows the buy tokens tab 922, where the equity 924 tab is selected. FIG. 18 shows the buy tokens tab 922, where the governance 926 tab is selected. FIG. 19 shows the buy tokens tab 922, where the income 928 tab is selected. The equity tab may present, for example, equity tokens including the total tokens, the circulating supply, the available tokens, the cost per token, and so on. The governance tab may present, for example, governance percentage, and the income tab may present, for example, income percentage.

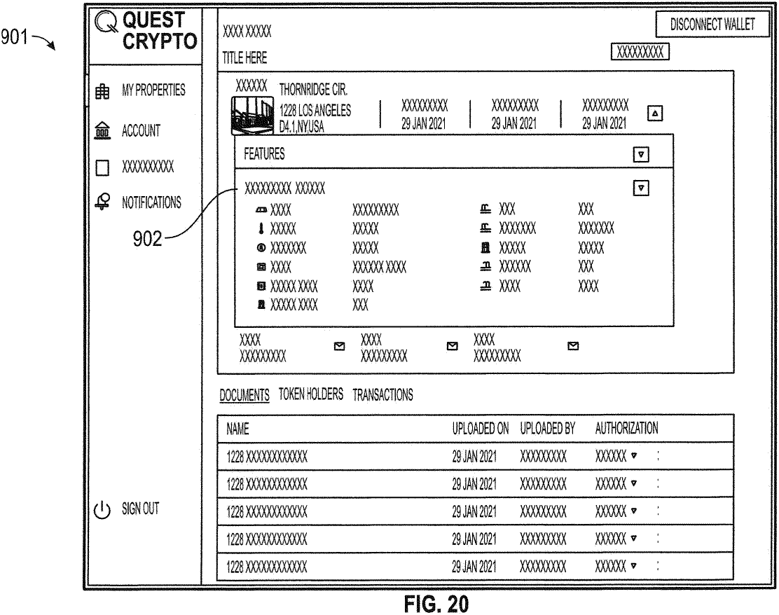

Referring to FIG. 20, the property intake software 36 generates a profile of the property for the purpose of creating a blockchain title registry, cryptocurrency, account, smart contract, blockchain and smart contract hyper ledger, and proper title documents for recordation with the local authority. The profile 901 as seen in the graphical user interface, includes the features of the property 902 such as how the house is heated, what type of shingles are on the roof, what type of floor, any outside features, and many other options. The graphical user interface shows these aspects in a clearly visible and understandable representation so that tile user can clearly understand and interpret the data in the profile.

The invention has been described utilizing real estate or real property. The invention can be used in conjunction with other types of property or possessions. Examples include, but are not limited to automobiles, art, gold, silver, minerals, precious gems, or other possessions.

Additionally, although the invention has been described with reference to a particular arrangement of parts, features and the like, these are not intended to exhaust all possible arrangements or features, and indeed many other modifications and variations will be ascertainable to those of skill in the art.

What is claimed is:

1. A method of automatically tokenizing property rights to convert to a crypto currency with an equity conversion computer having software executing thereon and having access to a network, the equity conversion computer performing the following steps:
presenting a property information intake page to a user computer associated with a user account including an electronic wallet, the property information intake page comprising a plurality of property information fields;
saving property information input into the plurality of property information fields on the storage in a first format;
automatically generating a property profile based on the property information saved on the storage and transmitting the property profile to the user computer;
generating documents granting property rights associated with the real property profile to a governing entity;
generating recordation documents for recording the property rights with a government recordation computer;
generating a smart contract associated with the property rights;
generating tokens associated with the smart contract;
recording the smart contract in blockchain; and
transferring the tokens to a wallet saved on the storage of the user computer.

2. The method of claim 1 further comprising the steps of:
displaying the tokenized property rights for purchase;
transferring a monetary value to the wallet; and
transferring the tokens from the wallet to a rights purchaser computer.

3. The method of claim 2 wherein the step of displaying the tokenized property rights for purchase is performed by the equity conversion computer.

4. The method of claim 2 wherein the step of transferring a monetary value to the wallet further comprises the steps of:
transferring the monetary value to the equity conversion computer, which then transfers the monetary value to the wallet.

5. The method of claim 2 wherein the step of transferring the tokens from the wallet to a rights purchaser computer further comprises the steps of:
transferring the tokens to the equity conversion computer from the wallet, which then transfers the tokens to the rights purchaser computer.

6. The method of claim 1 wherein the step of generating tokens associated with the property rights further comprises:
generating parent tokens; and
generating child tokens.

7. The method of claim 1 wherein the property rights are real property rights, and the governing entity comprises a Home Owners Association (HOA) or a Property Owners Association (POA).

8. The method of claim 7 wherein the tokenized real property rights are selected from the group consisting of: surface rights, subsurface rights, digital rights of display and combinations thereof.

9. The method of claim 8 wherein the surface rights are selected from the group consisting of: crops, livestock, timber, easement, carbon sink and combinations thereof.

10. The method of claim 8 wherein the subsurface rights are selected from the group consisting of: water, mineral, storage, easement, carbon sink, and combinations thereof.

11. The method of claim 7 wherein if the governing entity for the jurisdiction in which the real property rights are located does not exist, the method further comprises the steps of:
the equity conversion computer automatically generating governing entity documents in a second format to form the governing entity, the governing entity documents formatted to be automatically received by a government recordation computer; and
the equity conversion computer filing the governing entity documents with the government recordation computer.

12. The method of claim 1 wherein the electronic wallet comprises Anti-Money Laundering (AML) and Know Your Client (KYC) information.

13. The method of claim 1 further comprising the step of:
the equity conversion computer generating login credentials associated with a user accessing the equity conversion computer to create a user account;
wherein the wallet is generated by the equity conversion computer.

14. The method of claim 1 wherein the step of transmitting the property profile to the user computer further comprises:
the equity conversion computer receiving a confirmation from the user computer related to the property profile.

15. A system for automatically tokenizing property rights to convert to a crypto currency with a computer having access to a network, the system comprising:
an equity conversion computer having a storage and coupled to a network;
property intake software executing on said equity conversion computer presenting a property information intake page to a user computer via the network and associated with a user account having an electronic wallet, the property information intake page comprising a plurality of property information fields;
said property intake software saving property information input into the plurality of property information fields on the storage in a first format;
said property intake software automatically generating a property profile based on the property information saved on the storage and transmitting the property profile to the user computer;
property conversion software executing on said equity conversion computer generating documents granting property rights associated with the property profile to a governing entity;
said property conversion software generating recordation documents for recording the property rights with a government recordation computer;
said property conversion software generating a smart contract associated with the property rights;
said property conversion software generating tokens associated with the smart contract to generate tokenized property rights;
said property conversion software recording the smart contract in blockchain; and
said property conversion software transferring the tokens to a wallet saved on the storage of the user computer.

16. The system of claim 15 wherein:
said property transfer software executing on said equity conversion computer displays the tokens associated with the smart contract for purchase;
said property transfer software receiving a first monetary value from a rights purchaser computer;
said property transfer software transferring a second monetary value to the wallet; and
said property transfer software transferring the tokens from the wallet to the rights purchaser computer.

17. The system of claim 15 wherein when said property conversion software generates tokens, the tokens comprise:
parent tokens; and
child tokens.

18. The system of claim 15 wherein the property rights comprise real property rights and the governing entity comprises a Home Owners Association (HOA) or a Property Owners Association (POA).

19. The system of claim 18 wherein the tokenized real property rights are selected from the group consisting of: surface rights, subsurface rights, digital rights of display and combinations thereof.

20. The system of claim 19 wherein the surface rights are selected from the group consisting of: crops, livestock, timber, easement, carbon sink and combinations thereof.

21. The system of claim 19 wherein the subsurface rights are selected from the group consisting of: water, mineral, storage, easement, carbon sink, and combinations thereof.

22. The system of claim 18 wherein if the governing entity for the jurisdiction in which the real property rights are located does not exist:
said property conversion software automatically generates governing entity documents to form the governing entity, the governing entity documents formatted in a second format to be automatically received by a government recordation computer; and
said property conversion software filing the governing entity documents with the government recordation computer.

23. The system of claim 15 wherein the electronic wallet comprises Anti-Money Laundering (AML) and Know Your Client (KYC) information.

24. The system of claim 15 further comprising:
account creation software executing on said equity conversion computer, said account creation software generating login credentials associated with the user accessing the equity conversion computer to create a user account;
wherein the wallet associated with the user is generated by the account creation software.

25. The system of claim 15 wherein the step of transmitting the property profile to the user computer further comprises:
said property intake software receives a confirmation from the user computer related to the property profile.
